(19) United States
(12) Patent Application Publication
(10) Pub. No.: US 2026/0211803 A1
(43) Pub. Date: Jul. 23, 2026

(54) METHOD AND A SYSTEM FOR PROVIDING INTUITIVE TROUBLESHOOTING

(71) Applicant: Honeywell International, Inc., Charlotte, NC (US)

(72) Inventors: McMillan Goyal, Bengaluru (IN); Anjeneya Dubey, West Windsor, NJ (US); Malarvizhi Ganesan, Madurai (IN); Kiran Ashok, Bengaluru (IN); Abhiram Puranam, Bengaluru (IN); Maneesh Madathil Poyil, Dunwoody, GA (US); Debabrata Palai, Atlanta, GA (US); Sham Sharma, Atlanta, GA (US); Faizan Teli, Srinagar (IN)

(21) Appl. No.: 19/033,603

(22) Filed: Jan. 22, 2025

(51) Int. Cl. G06F 11/3698

(52) U.S. Cl. CPC G06F 11/3698

(57) ABSTRACT

The present disclosure relates to a method and a system for providing intuitive troubleshooting. The method comprises receiving a query from at least one user, the query identifies at least one problem, identifying, based on the query, one or more software applications associated with the at least one problem, retrieving logs and metrics of the one or more software applications associated with the at least one problem, extracting data from the logs and metrics of the one or more software applications associated with the at least one problem, analyzing the extracted data to identify a root cause associated with the at least one problem, accessing one or more information sources for generating at least one troubleshoot action based on the analyzed data, wherein the information sources include at least one localized knowledge database, and generating, by a generative artificial intelligence (GenAI) model, at least one troubleshoot action based on the access to the one or more information sources and the analyzed data and presenting, to the user, the at least one troubleshoot action for execution.

### FIELD

The present disclosure generally relates to troubleshooting of technical problems. More specifically, the present disclosure provides a method and a system for providing intuitive troubleshooting.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Software applications are often developed, deployed, and run on cloud computing environments where different users work on separate modules of an application. Various operations like development, testing, maintenance, issue-reporting, and delivery related to such applications often require troubleshooting. Since a variety of issues may occur in a software application, including its modules and operating environment, substantial IT resources are required. This results in a high cost of development and maintenance of the software application. Since some of the issues occur frequently, a substantial amount of time is spent by IT support engineers in resolving frequently occurring issues for multiple times.

Conventionally, the troubleshooting operations are manually done by specialist engineers. Further, in some scenarios the troubleshooting operations may require a substantial amount of time depending on the complexity of the technical problem. Hence, the manual approaches for implementing the troubleshooting operations are not efficient. In order to reduce the inefficiencies, recently there have been some efforts to use artificial intelligence (AI) techniques to augment IT support operations. Such efforts focus on achieving automation in specific aspects of troubleshooting. However, present AI techniques have various shortcomings. Often, the existing AI-based methods of troubleshooting provide solutions to a single issue associated with an application without considering the other applications which may be relevant to the technical issue. For example, current AI-based troubleshooting systems may focus solely on resolving connectivity problems within a specific software application, overlooking the potential impact that issues in other interconnected applications or systems could have on the overall technical problem. Accordingly, the current approaches lack a comprehensive analysis to diagnose the underlying problem accurately. Thus, multiple iterations are required in troubleshooting a single issue.

According to some conventional methods, the troubleshooting actions are provided by using localized knowledge base that contains predefined troubleshooting solutions and the like. Thus, the number of troubleshooting actions that can be provided by using the conventional methods is limited. Furthermore, the existing solutions are not intuitive and often require execution of multiple steps which are to be planned by the engineers in advance. The probability of successful execution of a troubleshoot action may suffer if any of the multiple steps are executed incorrectly. For example, network issues often require engineers to navigate through multiple technical steps, such as manually configuring network settings, checking hardware connections, and analysing software logs. If any of these steps are performed incorrectly, the likelihood of successfully resolving the network problem decreases.

Accordingly, there is a need for providing an improved method and system that can comprehensively analyze and provide troubleshoot actions for the technical problems more intuitively. Through applied effort, ingenuity, and innovation, the inventors have solved the above problem(s) by developing the solutions embodied in the present disclosure, the details of which are described further herein.

### SUMMARY

In general, embodiments of the present disclosure herein provide troubleshooting of problems by generating troubleshoot action by a generative artificial intelligence (GenAI) model. Other implementations will be, or will become, apparent to one with skill in the art upon examination of the following figures and detailed description. It is intended that all such additional implementations be included within this description be within the scope of the disclosure and be protected within the scope of the following claims.

In one embodiment, the present disclosure provides a method for providing intuitive troubleshooting, comprising receiving a query from at least one user, the query identifies at least one problem, identifying, based on the query, one or more software applications associated with the at least one problem, retrieving logs and metrics of the one or more software applications associated with the at least one problem, extracting data from the logs and metrics of the one or more software applications associated with the at least one problem, analyzing the extracted data to identify a root cause associated with the at least one problem, accessing one or more information sources for generating at least one troubleshoot action based on the analyzed data, wherein the information sources include at least one localized knowledge database, and generating, by a generative artificial intelligence (GenAI) model, at least one troubleshoot action based on the access to the one or more information sources and the analyzed data, and presenting, to the user, the at least one troubleshoot action for execution.

In an embodiment, the query is a text query inputted by the user in a query submission form.

In another embodiment, the method further comprises executing the troubleshoot action upon receiving user input.

In another embodiment, the method further comprises identifying a contextual meaning of the text query by a large language model (LLM), and determining based on contextual meaning, at least one problem associated with one or more software applications.

In yet another embodiment, the method further comprises receiving a feedback from the user on the at least one generated troubleshoot action, assigning a confidence score to the generated troubleshoot action, and updating the generative artificial intelligence (GenAI) model based on the feedback received from the user.

In another embodiment, the method further comprises accessing the one or more information sources for retrieving a new troubleshoot action, upon determining that the executed troubleshoot action has failed to rectify the problem.

In an embodiment, the one or more software applications associated with the identified problem are third party software applications.

In yet another embodiment, the method comprises accepting access from one or more software applications for retrieving logs and metrics of the one or more software applications.

In another embodiment, the method further comprises determining if the troubleshoot action has rectified the identified problem, and updating a tracker tool, upon determining that the identified problem has been rectified.

In another embodiment, the one or more information sources include a global knowledge database.

In another embodiment, the present disclosure provides a system for providing intuitive troubleshooting comprising a processor, a memory storing program instructions which, when executed by the processor, causes the processor to receive a query from at least one user, the query identifies at least one problem, identify, based on the query, one or more software applications associated with the at least one problem, retrieve logs and metrics of the one or more software applications associated with the at least one problem, extract data from the logs and metrics of the one or more software applications associated with the at least one problem, analyze the extracted data to identify a root cause associated with the at least one problem, access one or more information sources for generating at least one troubleshoot action based on the analyzed data, wherein the information sources include at least one localized knowledge database, and generate, by a generative artificial intelligence (GenAI) model, at least one troubleshoot action based on the access to the one or more information sources and the analyzed data, and present, to the user, the at least one troubleshoot action for execution.

In an embodiment, the processor is further configured to execute the troubleshoot action upon receiving user input.

In yet another embodiment, the processor is further configured to execute the troubleshoot action upon receiving user input.

In another embodiment, the processor is further configured to identify a contextual meaning of the text query by a large language model (LLM), and determine based on contextual meaning, at least one problem associated with one or more software applications.

In another embodiment, the processor is further configured to receive a feedback from the user on the at least one generated troubleshoot action, assign a confidence score to the generated troubleshoot action, and update the generative artificial intelligence (GenAI) model based on the feedback received from the user.

In yet another embodiment, the processor is further configured to access the one or more information sources for retrieving a new troubleshoot action, upon determining that the executed troubleshoot action has failed to rectify the problem.

In a further embodiment, the processor is further configured to accept access from one or more software applications for retrieving logs and metrics of the one or more software applications.

In an embodiment, the processor is further configured to determine if the troubleshoot action has rectified the identified problem, and update a tracker tool, upon determining that the identified problem has been rectified.

In yet another embodiment, the present disclosure provides a non-transitory computer-readable storage medium storing program instructions for providing intuitive troubleshooting, the instructions, when executed, perform the steps of receiving a query from at least one user, the query identifies at least one problem, identifying, based on the query, one or more software applications associated with the at least one problem, retrieving logs and metrics of the one or more software applications associated with the at least one problem, extracting data from the logs and metrics of the one or more software applications associated with the at least one problem, analyzing the extracted data to identify a root cause associated with the at least one problem, accessing one or more information sources for generating at least one troubleshoot action based on the analyzed data, wherein the information sources include at least one localized knowledge database, and generating, at least one troubleshoot action based on the access to the one or more information sources and the analyzed data, and presenting, to the user, the at least one troubleshoot action for execution.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an architecture of a system for providing intuitive troubleshooting, in accordance with an embodiment of the present disclosure;

FIG. 2 illustrates a detailed block diagram of the system, in accordance with an embodiment of the present disclosure;

FIG. 3 illustrates a detailed block diagram of a query receiving module and an identification module, in accordance with an embodiment of the present disclosure;

FIG. 4 illustrates an exemplary troubleshooting interface, in accordance with an embodiment of the present disclosure;

FIG. 5 illustrates a detailed block diagram of module-based operation of the feedback collection and updating of the GenAI model, in accordance with an embodiment of the present disclosure;

FIG. 6 illustrates a block diagram of module-based operation of the updating of a tracker tool, in accordance with an embodiment of the present disclosure;

FIG. 7 illustrates a detailed block diagram of module-based operation of the log and metrics retrieval, extraction and analysis in accordance with an embodiment of the present disclosure;

FIG. 8 illustrates a method for providing intuitive troubleshooting, in accordance with an embodiment of the present disclosure;

FIG. 9 illustrates a method for providing intuitive troubleshooting, in accordance with an embodiment of the present disclosure; and

FIG. 10 illustrates a block diagram of components of a system in accordance with an embodiment of the present disclosure.

### DETAILED DESCRIPTION OF THE INVENTION

The detailed description set forth below in connection with the appended drawings is intended as a description of various embodiments of the present disclosure and is not intended to represent the only embodiments in which the present disclosure may be practiced. Each embodiment described in this invention is provided merely as an example or illustration of the present disclosure, and should not necessarily be construed as preferred or advantageous over other embodiments. The detailed description includes specific details for the purpose of providing a thorough understanding of the present disclosure. However, it will be apparent to those skilled in the art that the present disclosure may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

The present disclosure relates to a method and a system for providing intuitive troubleshooting. According to an embodiment, a query regarding a problem that needs troubleshooting is received from a user. Based on the query, one or more software applications that are associated with the problem are identified. In an embodiment, in order to identify the root cause of the problem, the logs and metrics of the associated software applications are retrieved. Thereafter, the data associated with the logs and metrics is extracted and analyzed. Further, in order to find the troubleshoot action, one or more information sources are accessed based on the analyzed data. The information sources can be a localized knowledge database or a global knowledge database. Based on the accessed information sources and the analyzed data, the troubleshoot action is generated by a generative artificial intelligence (GenAI) model. The troubleshoot action is presented to a user for execution. The method and system of the present disclosure thus automate the troubleshooting process and achieves reduction in time and costs required in troubleshooting of various problems. The forthcoming paragraphs will explain the method in detail.

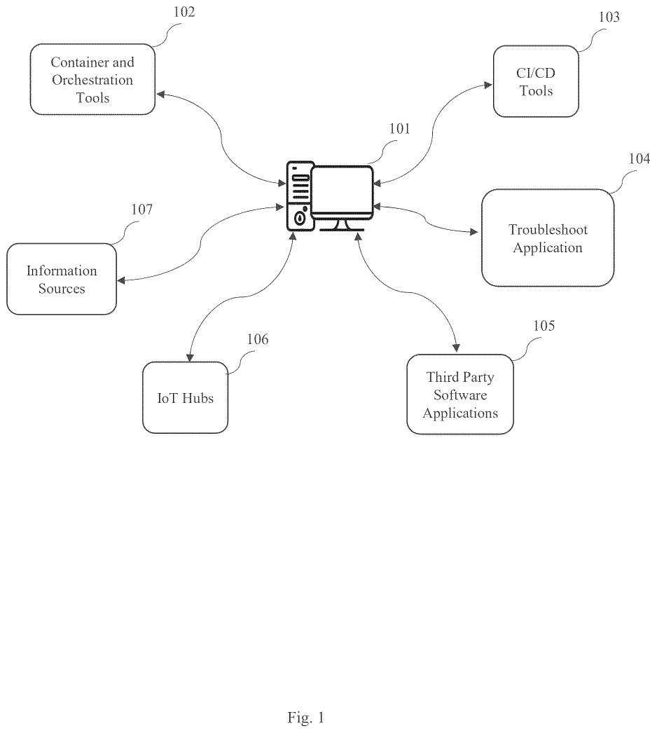

FIG. 1 illustrates an architecture of a system for providing intuitive troubleshooting, in accordance with an embodiment of the present disclosure. In an embodiment, the system 101 is connected to one or more container and orchestration tools 102, one or more Continuous Improvement/Continuous Development (CI/CD) tools 103, a troubleshoot application 104, one or more third party software applications 105, one or more Internet of Things (IoT) Hubs 106, and one or more information sources 107 through a network. The container and orchestration tools 102 include any tool that enables creation or management of containerization and/or orchestration of software code. The CI/CD tool 103 includes any tool that maintains, creates, builds or deploys a software code or update using continuous integration and continuous deployment practices. The troubleshoot application 104 is an application that is configured to execute various embodiments of the present disclosure. The IoT Hub 106 includes any tool that is used to manage and control various devices connected using IoT and related technologies.

In some embodiments, the network may be a public network (e.g., the Internet), a private network (e.g., an internal localized, or closed-off network between particular devices). In some other embodiments, the network may be a hybrid network (e.g., a network enabling internal communications between particular connected devices and external communications with other devices). In various embodiments, the network may include one or more relay(s), router(s), switch(es), routing station(s), and/or the like.

The system 101 is thus connected to the variety of tools that are employed in software development, delivery, and maintenance. In the present disclosure the words “tools” and “software applications” have been used interchangeably. The third party software application 105 here refers to a variety of applications that are developed by different organizations. The ability of the system 101 to troubleshoot problems is not limited to any specific tools or software applications. As long as the logs and metrics of a particular software application are accessible by the system 101, the system 101 can be used by a user for troubleshooting problems of that particular software application. The information sources 107 are knowledge databases that are accessed to find troubleshoot actions for problems. Such knowledge databases contain solutions for specific problems. The information source 107 may be localized i.e. developed by an enterprise running the system 101 or global. A global information source may be a source that is external to the system 101 and that can be accessed through an internet or other communication protocol.

In an embodiment, the system 101 updates the localized knowledge database on the basis of a user feedback on the troubleshoot action. Further, Artificial Intelligence (AI) or Machine Learning (ML) techniques can also be employed to train and update the localized knowledge database.

For instance, if the system 101 accesses the global knowledge database for the troubleshoot action and the same is found satisfactory by the user, the localized knowledge database may be updated. Thus, in future, the same troubleshoot action is accessed by the system 101 first in troubleshooting of an identical problem during an access of the localized knowledge database. In an embodiment, the system 101 receives an input in form of a query from the user via a user interface (UI) and displaying output in the form of the troubleshoot action.

The system 101 is configured to access the logs and metrics of the container and orchestration tools 102, the CI/CD tools 103, the third party software applications 105 and the IoT Hubs 106 to identify the root cause of a problem that needs troubleshooting. Since logs and metrics record different performance parameters, runtime information, errors etc., they are analyzed to identify root cause of a problem.

In an embodiment, the troubleshoot application 104 is a software application through which user can enter the query for troubleshooting the problem by using the system 101. In an embodiment, the troubleshoot application 104 may be in the form of a chatbot that receives a query from the user and generates replies automatically for troubleshooting a problem. The troubleshoot application 104 may also be integrated into the third party software application 105 over which developers and engineers collaborate on a project. For example, engineers collaborating on a software update on the CI/CD tool 103 may execute the troubleshoot application 104 in real time if they encounter a technical problem. The troubleshoot application 104 may also be integrated in any other application by way of a plugin or an extension. In another embodiment, the troubleshoot application 104 may be integrated in a video conferencing software application. The IoT hubs 106 connected to the system 101 provide information related to functioning of IoT devices. Thus, if any IoT device connected to the IoT hub 106 encounters a problem, the troubleshoot application 104 can be used for troubleshooting it.

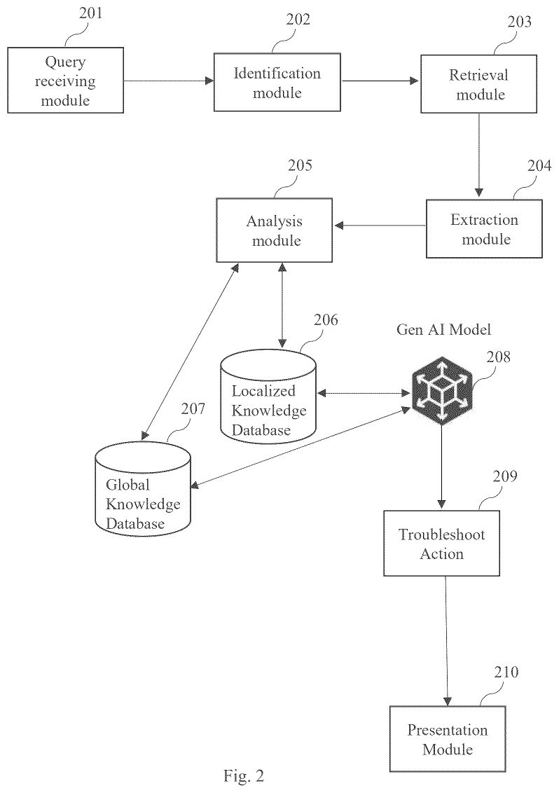

FIG. 2 illustrates a detailed block diagram of the system of FIG. 1, in accordance with an embodiment of the present disclosure. According to an embodiment, the query receiving module 201 receives a query from at least one user. The query receiving module 201 analyzes the query and identifies at least one problem that requires troubleshooting. In an embodiment, the query inputted by the user may be a text based query. In an embodiment, the query receiving module 201 identifies a contextual meaning of a text query by a large language model (LLM).

On the basis of the query, the identification module 202 identifies one or more software applications associated with the problem. In this regard, the identification module 202 may refer to a database that contains a list of problems and associated software applications. In some of situations, a successful resolution of a problem may involve fixing an issue in more than one software application. For example, a problem that arises in a project in the CI/CD Tool 103 may be caused due to an issue in an activity incorrectly performed in the Container and Orchestration Tool 102. In such a scenario, repeated attempts at addressing the problem of the CI/CD Tool 103 may not result in successful resolution. By identifying all the software applications associated with a problem, the identification module 202 increases the likelihood of generating a correct troubleshoot action in fewer iterations.

In an embodiment, the identification module 202 sends a list of the software applications associated with a problem to the retrieval module 203. The retrieval module 203 then accesses and retrieves the logs and metrics of the software applications associated with the problem.

After retrieving the logs and metrics, the retrieval module 203 sends the logs and metrics to an extraction module 204. In an embodiment, the extraction module 204 extracts data from the logs and metrics that is relevant to the problem. For example, in a technical problem related to deployment in the container and orchestration tool 102, an event log may be relevant to the problem.

The extraction module 204 includes a database that maintains a list of data of logs and metrics which might be relevant for a particular problem in a particular software application. In an embodiment, the database of the extraction module 204 can be updated by the user. Further, according to some embodiments, the Artificial Intelligence (AI) or Machine Learning (ML) techniques can also be employed to train and update the database.

According to an embodiment, the extracted data is sent to an analysis module 205 for further analysis. Further, the analysis module 205 analyses the extracted data to identify a root cause associated with the at least one problem. As an example, the analysis module 205 is configured to use machine learning techniques for analysing the extracted data. Once the analysis module 205 identifies a root cause associated with the at least one problem, it accesses one or more information sources for determining at least one troubleshoot action of the problem. The information sources include at least one localized knowledge database 206 and a global knowledge database 207.

In an embodiment, the localized knowledge database 206 is maintained locally and can be updated by the user of the system 101. Further, the global knowledge database 207 may be a database other than the localized knowledge database 206. The system 101 can be configured to access any global knowledge database 207 after obtaining authorization. In one of the embodiments, if the localized database 206 does not contain a troubleshoot action then the analysis module 205 accesses the global knowledge database 207. In another embodiment, both localized knowledge database 206 and the global knowledge database 207 are accessed and analyzed by the analysis module 205.

The results of access to the localized knowledge database 206 and the global knowledge database 207 are sent to a GenAI model 208. In an embodiment, the GenAI model 208 runs various processes to generate one or more troubleshoot actions that successfully resolves the problem. The GenAI model 208 is also configured to update the localized knowledge database 206. The generated troubleshoot action 209 is sent to a presentation module 211. The presentation module 211 is a part of the system 101 that presents the troubleshoot action to the user. The presentation module 211 may be coupled with a display of the system 101.

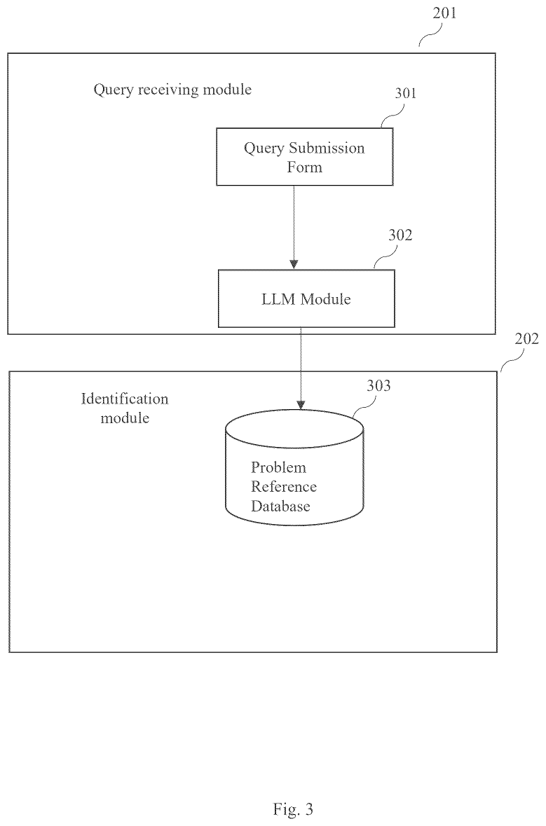

FIG. 3 illustrates a detailed block diagram of the query receiving module 201 and the identification module 202 of the system 101 of FIG. 1. In an embodiment, the query receiving module 201 generates a query submission form 301. The query receiving module 201 further includes a large language model (LLM) Module 302. According to an embodiment, the user enters a query describing a problem in the query submission form 301. As an example, the query entered by the user is a text query. In an embodiment, the query received by the query submission form 301 is sent to the LLM module 302 for further processing. In an embodiment, the LLM module 302 is configured to identify the contextual meaning of the text query by using the large language model (LLM). The LLM module 302 then sends its results to the identification module 202. The identification module 202 identifies the problem on the basis of output of the LLM module 302.

In an embodiment, the identification module 202 includes a problem reference database 303 which includes information with respect to problems and the software applications associated with said problems. For instance, the user of the system 101 enters the query stating the problem related to deployment of a software update in the CI/CD tool 103. The identification module 202 then accesses the problem reference database 303 which contains information that for the problem related to deployment of a software update in the CI/CD tool 103, the container and orchestration tool 102 will also be relevant. The problem reference database 303 can be updated manually or automatically on the basis of feedback of the user after presentation or execution of the troubleshoot action. According to some embodiments, the Artificial Intelligence (AI) or the Machine Learning (ML) techniques can also be employed to train and update the problem reference database 303.

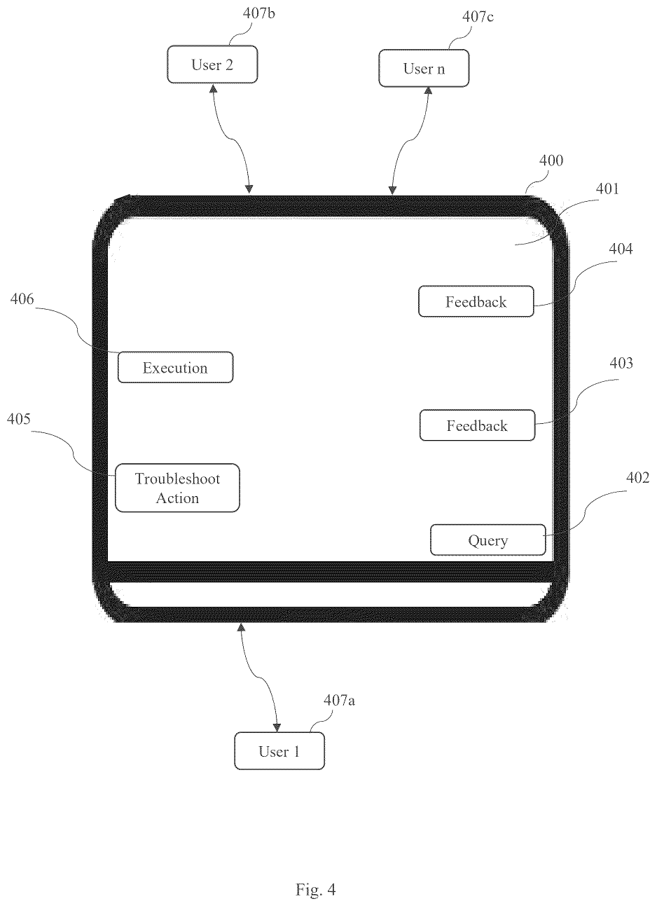

FIG. 4 illustrates an exemplary troubleshooting interface in accordance with an embodiment of the present disclosure. According to an exemplary embodiment, the troubleshoot assistant can be a chatbot 401 as depicted in FIG. 4. In an embodiment, the chatbot 401 is used for interaction with a user 407a and presentation of the troubleshoot action using a display unit. In some of the embodiments, a plurality of users 407a, 407b and 407c (collectively referred by reference numeral 407) may also be connected to the system 101. In an embodiment, the chatbot 401 is configured for performing operations automatically upon receiving the user input. The chatbot 401 interacts with the user 407 through a plurality of textboxes or forms for receiving input and presenting the output.

In an embodiment, the chatbot 401 is configured to receive query in text-based form or any other form. Further, the chatbot 401 can also receive query sequentially seeking inputs from the user 407 to gather problem related details.

Further, the user 407, enters the query in a text box 402. In an embodiment, the system 101 after carrying out necessary processes as explained above through FIGS. 2 and 3 generates a troubleshoot action 405. In some of the embodiments, the troubleshoot action 405 may be in a textual format where suggestions are made to the user 407. According to some embodiments, the chatbot 401 can be configured to implement the suggestions of the user 407 and access relevant information or execute any instruction using API calls.

In some of the embodiments, the troubleshoot action 405 may comprises of a plurality of actions to be taken by the user 407. Further, the user 407 may provide the feedback 403 on the troubleshoot action 405. For instance, if the user 407 opines that the probability of the troubleshoot action 405 solving a problem is low then the feedback 403 may be negative. In such a scenario, the system 101 will search for a new troubleshoot action by carrying out necessary processes through the modules explained in FIG. 2 above. The feedback 403 may be in the form of pre-defined options that are generated for selection by the user 407. The feedback 403 may alternatively be entered in text form where the user 407 gives a detailed feedback and any suggestions. For instance, the user 407 may suggest the name of a particular information source for finding the troubleshoot action.

Upon receiving the feedback 403 which is positive, the chatbot 401 asks the user 407 if execution 406 is needed. Upon receiving an input from the user 407, the system 101 executes the troubleshoot action. This troubleshoot action may involve a plurality of activities like fixing an error in a log, running a program script, retrieving a piece of information etc. The chatbot 401 then asks feedback 404 on the executed troubleshoot action from the user 407. The chatbot 401 thus provides an intuitive way for troubleshooting problems.

In some of the embodiments, any one of the users 407 may perform a part of activity of the troubleshoot process by using chatbot 401. For example, while the query 402 may be submitted upon input of user 407a, the feedback 404 may be submitted by the user 407c. The chatbot 401 is also configured to make updates to a software application used for monitoring troubleshooting like JIRA so as to indicate that the problem has been resolved or not.

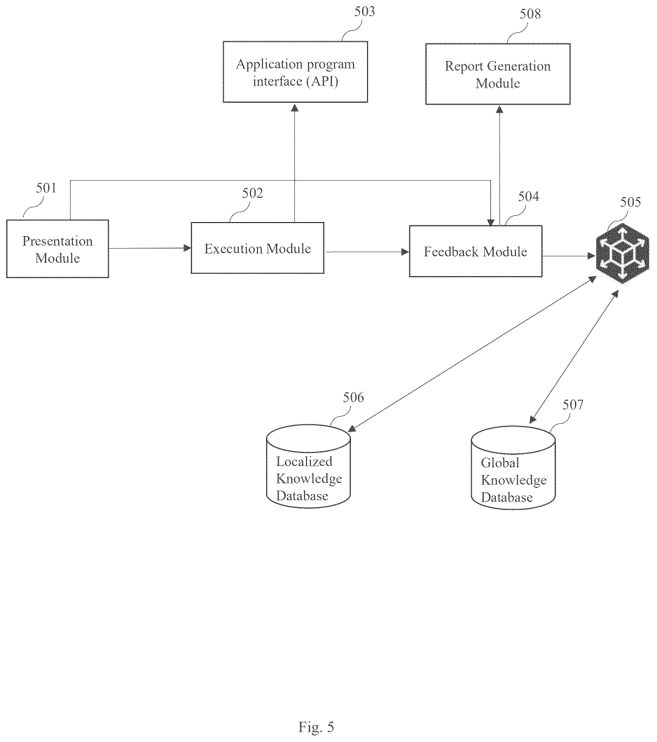

FIG. 5 illustrates a detailed block diagram of module-based operation of the feedback collection and updating of the GenAI model, in accordance with an embodiment of the present disclosure;

[symbol]

After presenting a troubleshoot action to the user by a presentation module 501, the system 101 seeks the feedback through a feedback module 504, from the user. In an embodiment, the feedback module 504 receives the feedback before or after execution of the troubleshoot action.

In cases where after presentation of the troubleshoot action by the presentation module 501, the user decides to execute the troubleshoot action, the presentation module 501 sends the troubleshoot action to an execution module 502. The execution module 502 executes the troubleshoot action through application program interface (API) 503 calls. If the troubleshoot action requires sending a message or any communication to any other user 407 connected to the system 101, then the execution module 502 is configured to send the message or any communication.

After the execution of the troubleshoot action, the feedback module 504 collects feedback from the user on the executed troubleshoot action. The feedback module 504 is configured to receive feedback in the form of options or levels and a text. The feedback module 504 is further configured to understand the text based feedback by using a large language model (LLM).

In an embodiment, the feedback module 504 sends the user feedback to a GenAI model 505. If the feedback given in the feedback module 504 is negative then the GenAI model 505 accesses a localized knowledge database 506 and a global knowledge database 507 again for finding the troubleshoot action.

The localized knowledge database 506 and the global knowledge database 507 contain information with respect to the problem and corresponding troubleshoot actions. The localized knowledge database 506 contains a field indicating a confidence score of the troubleshoot action. In an embodiment, when the user is satisfied with the troubleshoot action and indicates the same in the feedback module 504, the GenAI model 505 assigns the confidence score to the troubleshoot action in the localized knowledge database 506. If the troubleshoot action is already assigned the confidence score, then the GenAI model updates it to indicate a higher confidence in the troubleshoot action. The GenAI model 505 is configured to process the troubleshoot action with the highest confidence score first. Conversely, if the user inputs a negative feedback on the troubleshoot action in the feedback module 504, the GenAI model 505 may be configured to decrease the confidence score of the troubleshoot action in the localized knowledge database 506.

The GenAI model 505 may be configured to not select for processing the troubleshoot action having a confidence score below a pre-defined level. In some of the embodiments, the user may indicate in the feedback module 504 that the global knowledge database 507 should be accessed first for finding the troubleshoot action.

The GenAI model 505 may also be configured to adopt the troubleshoot action from the global knowledge database 507 and enter it into the localized knowledge database 506 and assign it a confidence score. For instance, if the user does not find any of the troubleshoot actions generated by accessing the localized knowledge database 506, satisfactory then the GenAI model 505 generates the troubleshoot action by accessing the global knowledge database 507. The GenAI model 505 upon receiving input from the feedback module 504 updates or creates a new entry in the localized database 506.

Further, if a particular troubleshoot action for a particular problem in the localized knowledge database 506 fails to solve the problem, then the GenAI model 505 can remove that entry from the knowledge database 506 upon receiving an input from the user. The GenAI model 505 may also be configured to automatically remove an entry from the knowledge database 506 if it receives a predefined number of negative feedbacks from the user on the troubleshoot action.

The feedback module 504 sends its input to a report generation module 508 which generates a report recording the history of the troubleshoot process. The report may contain a plurality of information like details of the user, identified problem, associated software applications, time taken for generating the troubleshoot action, generated troubleshoot action, whether troubleshoot action was executed, feedback of the user on the troubleshoot action, any updates made to the GenAI model 505 after the end of the troubleshoot action. The generated reports may be read by the user to monitor performance of the intuitive troubleshooting method and system. The generated reports may help users to do resource planning of the infrastructure involved in the system and the method. The decision to scale the system to meet new requirements can be made accordingly.

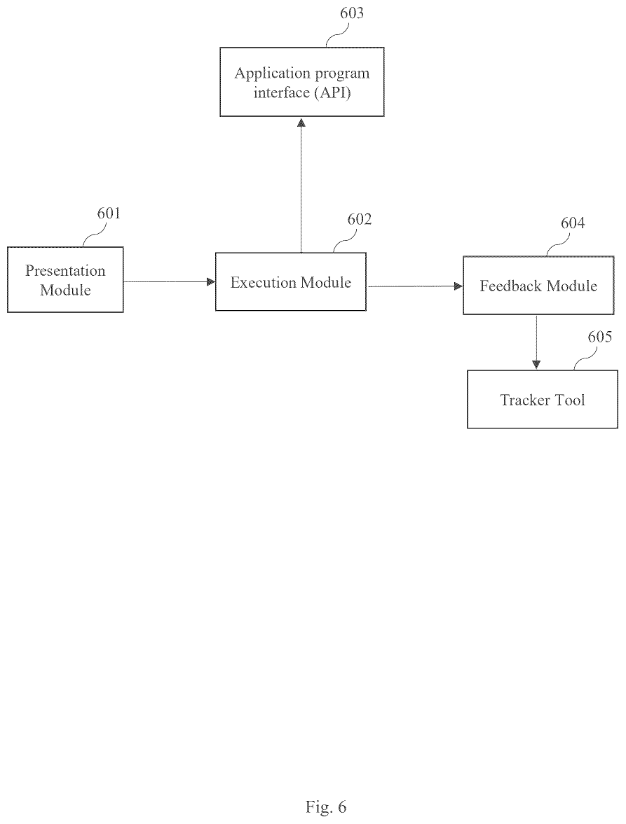

FIG. 6 illustrates a block diagram of module-based operation of the updating of a tracker tool, in accordance with an embodiment of the present disclosure. As shown in FIG. 6, the troubleshoot action is presented to the user in a presentation module 601. If the user decides to execute the troubleshoot action then an input is given to an execution module 602. The execution module 602 executes the troubleshoot action through API calls 603.

The execution module 602 sends an input to a feedback module 604 indicating that the troubleshoot action has been executed. The feedback module 604 then collects the feedback of the user. Upon receiving a positive feedback, the feedback module 604 prompts a user to update a tracker tool 605. The tracker tool 605 is an application that is used in software development for collaboration among users (for example JIRA).

The system 101 can be configured to work with any tracker tool as long as required access and credentials have been given to the system 101. If the tracker tool 605 has an open ticket with respect to a problem whose troubleshoot action is being searched by the system 101, then the said ticket can be updated by the system 101 if the user wishes to.

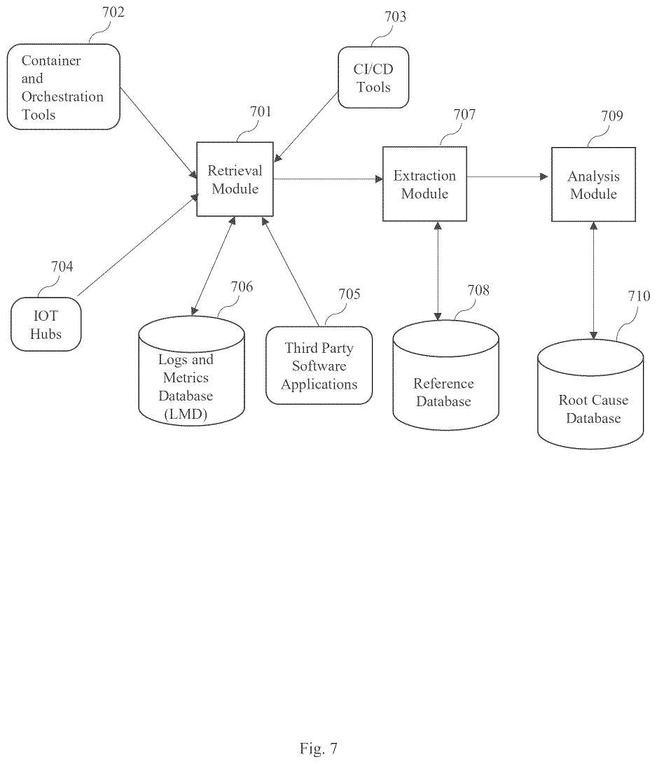

FIG. 7 illustrates a block diagram of module-based operation of the log and metrics retrieval, extraction and analysis in accordance with an embodiment of the present disclosure. As shown in FIG. 7, a retrieval module 701 collects logs and metrics of the one or more container and orchestration tools 702, the one or more CI/CD Tools 703, the one or more IoT Hubs 704 and any Third Party Software Applications 705. The retrieval module 701 retrieves the logs and metrics by using API calls. The retrieval module 701 retrieves the logs and metrics of the software applications that are associated with the problem whose troubleshoot action is intended to be generated.

The retrieval module 701 accesses a logs and metrics database (LMD) 706 t find the logs and metrics of the software applications that are relevant to the problem. Input regarding the one or more software applications associated with the problem is provided to the retrieval module 701 by the identification module 202 of FIG. 2.

The LMD 706 contains entries with respect to a problem, associated software applications and their relevant logs and metrics. For example, for a problem related to network access in the CI/CD tool 703, the LMD 706 may contain information related to, list of logs and metrics of the software applications that will likely contain an insight with respect to the problem or logs and metrics that will record an error or issue related to the problem. The LMD 706 can be updated by the user of the system 101. Artificial Intelligence (AI) or Machine Learning (ML) techniques can also be employed to train and update the LMD 706.

The retrieval module 701 sends the retrieved logs and metrics to an extraction module 707. The extraction module 707 extracts data from the logs and metrics of the one or more software applications associated with the problem. The extraction module 707 is connected to a reference database 708.

The reference database 708 contains information with respect to the specific information of particular logs and metrics sent by the retrieval module 701 that will provide insight for troubleshooting the problem. Since any log or metrics of a software application can contain a large amount of data, it is necessary to extract only the data that will contain information related to the problem. Artificial Intelligence (AI) or Machine Learning (ML) techniques can also be employed to train and update the reference database 708.

The extracted data is then sent to an analysis module 709 for finding a root cause associated with the problem. The analysis module 709 runs various processes and analyses the extracted data. In this regard, the analysis module 709 is connected to a root cause database 710. The root cause database 710 contains information related to extracted data and probable root causes that can be stored by the analysis module 709. The root cause database 710 may also contain a field indicating the probability of a root cause associated with the problem. For example, if the root cause database 710 lists four probably root causes of the problem, then the analysis module 709 will choose the root cause which is more likely to be the root cause of the problem as compared to the other root causes. The analysis module 709 may be configured to update probability field of a particular entry in the root cause database 710 on the basis of feedback given by the user in the feedback module 504 explained in FIG. 5, after generation of the troubleshoot action.

For instance, the root cause database 710 may contain an entry that lists probable root causes of the problem with combinations of particular extracted data of particular logs of particular software applications. The root cause database 710 can be updated by the analysis module 709. Machine Learning (ML) techniques can also be employed to train and update root cause database 710. The analysis module 709 thus determines at least one root cause associated with the problem. Artificial Intelligence (AI) or Machine Learning (ML) techniques can also be employed to train and update the root cause database 710.

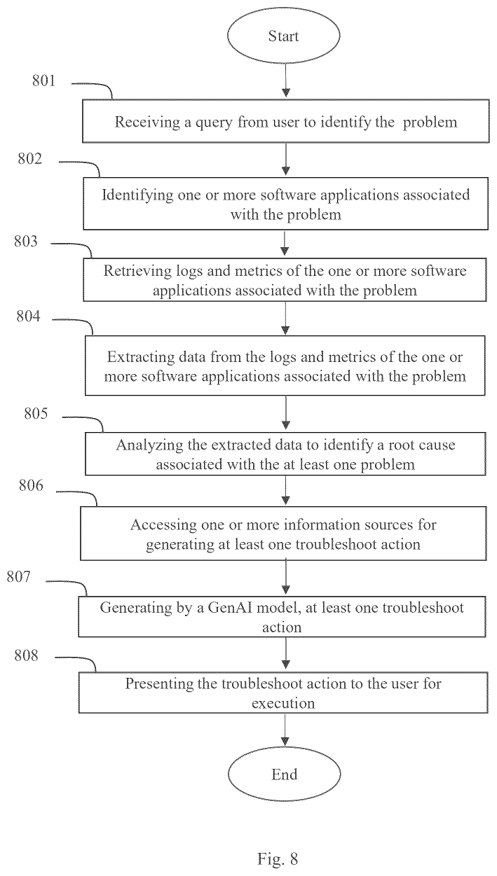

FIG. 8 illustrates a method for providing intuitive troubleshooting, in accordance with an embodiment of the present disclosure. The step 801 involves receiving a query from a user to identify at least one problem. The query may be received in the form of the text based query which is inputted by the user in a query submission form. The contextual meaning of the query can be identified by using large language model (LLM). The contextual meaning of the query is used to determine at least one problem associated with one or more software applications. The query is not required to be in any predefined syntax.

The step 802 involves identifying one or more software applications associated with the problem. It is necessary to identify the software applications associated with the problem because it possible that a problem related to one software application has been caused due to another software application especially in the situations where software applications exchange data. In order to identify one or more software applications associated with the problem, reference can be made to a problem reference database that contains entries related to problems and software applications that may be associated with the problems.

The step 803 involves retrieving logs and metrics of the one or more software applications associated with the problem. The logs and metrics of the one or more software applications associated with the problem are retrieved by the retrieval module which contains the logs and metrics database (LMD). The LMD contain entries with respect to a plurality of problems, associated software applications and relevant logs and metrics. The relevant logs and metrics are the logs and metrics that contain information that will be relevant to the troubleshooting of the problem.

The step 804 involves extracting data from the logs and metrics of the one or more software applications associated with the at least one problem. The data from the logs and metrics are extracted by the extraction module. The extraction module is connected to a reference database which contains entries with respect to to the specific information of particular logs and metrics sent by the retrieval module.

The step 805 involves analysing the extracted data to identify a root cause associated with the at least one problem. The analysis is performed by the analysis module. In order to perform the analysis, the analysis module is connected to a root cause database. The root cause database contains entries that relate specific combinations of extracted data with a list of probable root causes.

The step 806 involves accessing one or more information sources for generating at least one troubleshoot action. The information sources contain at least one localized knowledge database and a global knowledge database. The localized knowledge database is maintained locally by the enterprise. A global knowledge database is a database which is not a localized knowledge database. The global information source may also be a source that is external. Any global knowledge database can be accessed for generating at least one troubleshoot action as long as the user is authorized to do so.

The step 807 involves generating by the GenAI model, at least one troubleshoot action based on the access to the one or more information sources and the analyzed data. Then GenAI model runs various processes to determine one or more troubleshoot actions that successfully resolves the problem. If the GenAI model fails to generate a troubleshoot action on the basis of results of access to the localized database, then the GenAI model accesses the global knowledge database to find the troubleshoot action.

The step 808 involves presenting the at least one generated troubleshoot action to the user for execution. The generated troubleshoot action is presented in the presentation module. The user may decide to execute the troubleshoot action. If the user decides to execute the troubleshoot action, then the troubleshoot action is sent to an execution module for execution. The troubleshoot action is executed by the execution module through API calls.

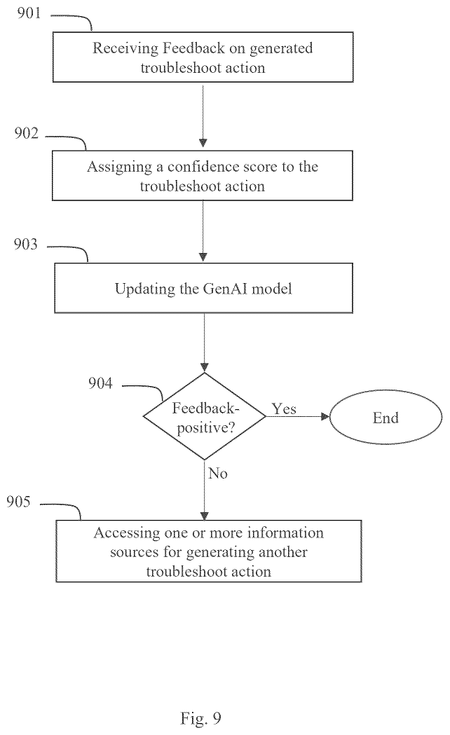

FIG. 9 illustrates a method for providing intuitive troubleshooting, in accordance with an embodiment of the present disclosure. The step 901 involves receiving a feedback on the generated troubleshoot action in the feedback module. The feedback may be given in the form of pre-defined options that are generated for selection by the user. The feedback may also be given in text form. The feedback module is configured to understand the text based feedback using a large language model (LLM). The feedback on the troubleshoot action may be given before or execution of the troubleshoot action. In the feedback given prior to execution of the troubleshoot action, the user may indicate that the global knowledge database should be accessed first for finding the troubleshoot action.

If the feedback on the troubleshoot action is positive, the GenAI model assigns a confidence score to the generated troubleshoot action in the localized knowledge database in step 902. If the confidence score is already assigned to the troubleshoot action then the GenAI model updates it to indicate higher confidence in the troubleshoot action if the feedback given by the user is positive. Conversely, if the feedback on the generated troubleshoot action is negative, the GenAI model decreases the value of the confidence score. If the troubleshoot action is generated by accessing the global knowledge database, then the GenAI model may enter it into the localized knowledge database and assign a confidence score to it.

Based on the feedback on the generated troubleshoot action, the GenAI model is updated in step 903 so that on a future troubleshooting operation on a similar problem, the GenAI model accesses the troubleshoot action with a higher confidence score.

In step 904, the method checks if the feedback given by the user is positive or negative. If the feedback is positive, then the method ends.

If the feedback given by the user is not positive, then the GenAI model in step 905 accesses one or more information sources for generating another troubleshoot action.

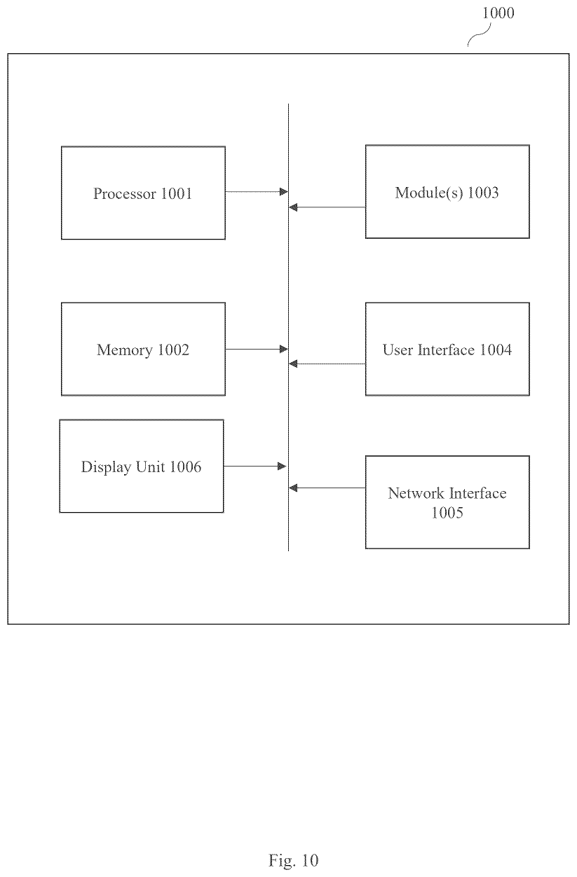

FIG. 10 illustrates a block diagram of a components of a system 1000 in accordance with an embodiment of the present disclosure. The system 1000 comprises a processor 1001, a memory 1002, a module(s) 1003, a user interface 1004, a network interface 1005 and display unit 1006.

The user may access the user interface 1004 and enter a query in the module(s) 1003. The module(s) 1003 here refer to a plurality of modules explained in the present disclosure. The module(s) 1003 contain various sub-modules that execute the method steps described in the present disclosure. The query entered by the user is provided as input to the processor 1001 which is connected to the memory 1002. The network interface 1005 comprises various hardware/software components through which users and various software applications connect to the system 1000. The network interface 1005 is also used for accessing various information sources and other databases explained in the present disclosure. The display unit 1006 displays the troubleshoot actions generated by the examples of the present disclosure. The display unit 1006 displays a chatbot that interacts with the user for troubleshooting a problem.

In some embodiments, the processor 1001 includes hardware, software, firmware, and/or a combination thereof that performs one or more operations described herein. The processor 1001 may be configured to execute instructions stored in the memory 1002 or otherwise accessible to the processor 1001. Alternatively, the processor 1001 may be configured to execute hard-coded functionality. As such, whether configured by hardware or software methods, or by a combination thereof, processor 1001 may represent an entity (e.g., physically embodied in circuitry) capable of performing operations according to embodiments of the present disclosure while configured accordingly.

Alternatively, the processor 1001 may be embodied as an executor of software instructions, and the instructions may specifically configure the processor 1001 to perform the various algorithms embodied in one or more operations described herein when such instructions are executed. In some embodiments, the processor 1001 includes hardware, software, firmware, and/or a combination thereof that performs one or more operations described herein. In some embodiments, the processor 1001 (and/or co-processor or any other processing circuitry assisting or otherwise associated with the processor) is/are in communication with the memory 1002 via a bus for passing information. Memory 1002 may be non-transitory and may include, for example, one or more volatile and/or non-volatile memories. In some embodiments, the memory 1002 includes or embodies an electronic storage device (e.g., a computer readable storage medium). In some embodiments, the memory 1002 is configured to store information, data, content, applications, instructions, or the like, for enabling processor 1001 to carry out various operations and/or functions in accordance with example embodiments of the present disclosure.

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

The user interface of the chatbot of the present disclosure may be developed using any user interface framework or tools like, but not limited to, ReactJS or Angular. For managing interactions, frameworks like but not limited to, Dialogflow or Microsoft Bot Framework may be used. To implement backend logic, API integrations and bot operations of the present disclosures, tools like, but not limited to, Golang or Node.js may be used. For scripting complex data processing tasks and integrating methods of the present disclosures with machine learning techniques, tools like but not limited to, Python may be used. For training LLM Models tools like, but not limited to, Python and machine libraries like, but not limited to, TensorFlow or PyTorch may be used. For efficient handling of vector data in GenAI model, vector database solutions like, but not limited to, Pinecone or Milvus may be used. The logs and metrics storage and retrieval can be implemented using Elasticsearch or any similar tool. Containerization tools like, but not limited to, Docker may be used for consistent deployment environments. For orchestration of containerized services, tools like, but not limited to, Kubernetes may be used. For scalable and reliable hosting of system of the present disclosures, tools like, but not limited to, AWS, Azure, or GCP. For creating CI/CD pipelines, tools like, but not limited to, Bamboo, Octopus and GitHub Actions may be used. For managing cloud resources, tools like, but not limited to, Terraform may be used.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1. A method for providing intuitive troubleshooting, comprising:
receiving a query from at least one user, the query identifies at least one problem;
identifying, based on the query, one or more software applications associated with the at least one problem;
retrieving logs and metrics of the one or more software applications associated with the at least one problem;
extracting data from the logs and metrics of the one or more software applications associated with the at least one problem;
analyzing the extracted data to identify a root cause associated with the at least one problem;
accessing one or more information sources for generating at least one troubleshoot action based on the analyzed data, wherein the information sources include at least one localized knowledge database; and
generating, by a generative artificial intelligence (GenAI) model, at least one troubleshoot action based on the access to the one or more information sources and the analyzed data; and
presenting, to the user, the at least one troubleshoot action for execution.

2. The method of claim 1, wherein the query is a text query inputted by the user in a query submission form.

3. The method of claim 1, further comprising:
executing the troubleshoot action upon receiving user input.

4. The method of claim 2, further comprising:
identifying a contextual meaning of the text query by a large language model (LLM); and
determining based on contextual meaning, at least one problem associated with one or more software applications.

5. The method of claim 1, further comprising:
receiving a feedback from the user on the at least one generated troubleshoot action;
assigning a confidence score to the generated troubleshoot action; and
updating the generative artificial intelligence (GenAI) model based on the feedback received from the user.

6. The method of claim 3, further comprising:
accessing the one or more information sources for retrieving a new troubleshoot action, upon determining that the executed troubleshoot action has failed to rectify the problem.

7. The method of claim 1, wherein the one or more software applications associated with the identified problem are third party software applications.

8. The method of claim 7, comprising:
accepting access from one or more software applications for retrieving logs and metrics of the one or more software applications.

9. The method of claim 3, further comprising:
determining if the troubleshoot action has rectified the identified problem; and
updating a tracker tool, upon determining that the identified problem has been rectified.

10. The method of claim 1, wherein the one or more information sources include a global knowledge database.

11. A system for providing intuitive troubleshooting, comprising:
a processor;
a memory storing program instructions which, when executed by the processor, causes the processor to:
receive a query from at least one user, the query identifies at least one problem;
identify, based on the query, one or more software applications associated with the at least one problem;
retrieve logs and metrics of the one or more software applications associated with the at least one problem;
extract data from the logs and metrics of the one or more software applications associated with the at least one problem;
analyze the extracted data to identify a root cause associated with the at least one problem;
access one or more information sources for generating at least one troubleshoot action based on the analyzed data, wherein the information sources include at least one localized knowledge database; and
generate, by a generative artificial intelligence (GenAI) model, at least one troubleshoot action based on the access to the one or more information sources and the analyzed data; and
present, to the user, the at least one troubleshoot action for execution.

12. The system of claim 11, wherein the query is a text query inputted by the user in a query submission form.

13. The system of claim 11, wherein the processor is further configured to:
execute the troubleshoot action upon receiving user input.

14. The system of claim 12, wherein the processor is further configured to:
identify a contextual meaning of the text query by a large language model (LLM); and
determine based on contextual meaning, at least one problem associated with one or more software applications.

15. The system of claim 11, wherein the processor is further configured to:
receive a feedback from the user on the at least one generated troubleshoot action;
assign a confidence score to the generated troubleshoot action; and
update the generative artificial intelligence (GenAI) model based on the feedback received from the user.

16. The system of claim 13, wherein the processor is further configured to:
access the one or more information sources for retrieving a new troubleshoot action, upon determining that the executed troubleshoot action has failed to rectify the problem.

17. The system of claim 11, wherein the one or more software applications associated with the identified problem are third party software applications.

18. The system of claim 17, wherein the processor is configured to:
accept access from one or more software applications for retrieving logs and metrics of the one or more software applications.

19. The system of claim 13, wherein the processor is configured to:
determine if the troubleshoot action has rectified the identified problem; and
update a tracker tool, upon determining that the identified problem has been rectified.

20. A non-transitory computer-readable storage medium storing program instructions for providing intuitive troubleshooting, the instructions, when executed, perform the steps of:
receiving a query from at least one user, the query identifies at least one problem;
identifying, based on the query, one or more software applications associated with the at least one problem;
retrieving logs and metrics of the one or more software applications associated with the at least one problem;
extracting data from the logs and metrics of the one or more software applications associated with the at least one problem;
analyzing the extracted data to identify a root cause associated with the at least one problem;
accessing one or more information sources for generating at least one troubleshoot action based on the analyzed data, wherein the information sources include at least one localized knowledge database; and
generating, at least one troubleshoot action based on the access to the one or more information sources and the analyzed data; and
presenting, to the user, the at least one troubleshoot action for execution.
